(19) United States
(12) Patent Application Publication
(10) Pub. No.: US 2026/0213048 A1
(43) Pub. Date: Jul. 23, 2026

(54) INSULATION FITTING

(71) Applicant: Georg Fischer Rohrleitungssysteme AG, Schaffhausen (CH)

(72) Inventors: Peter FEND, Monovar (ES); Fabian MANGER, Blumberg (DE)

(21) Appl. No.: 19/450,919

(22) Filed: Jan. 16, 2026

(30) Foreign Application Priority Data
Jan. 21, 2025 (EP) 25153124.0

(51) Int. Cl. H01B 17/58; F16L 9/147; H01B 3/42

(52) U.S. Cl. CPC H01B 17/58; F16L 9/147; H01B 3/427

(57) ABSTRACT

Insulation fitting for installation in a metal pipeline which is under an electrical voltage, containing a plastic pipe and connecting elements, arranged thereon on both sides, for connecting the insulation fitting to the metal pipeline, wherein the plastic pipe for the purpose of insulation is conductive.

### CROSS-REFERENCE TO RELATED APPLICATION

This application claims the benefit and priority of European Patent Application No. 25153124.0 filed Jan. 21, 2025. The entire disclosure of the above application is incorporated herein by reference.

### BACKGROUND OF THE INVENTION

### Technical Field

Insulation fitting for installation in a metal pipeline which is under an electrical voltage, containing a plastic pipe and connecting elements, arranged thereon on both sides, for connecting the insulation fitting to the metal pipeline.

### Discussion

In the case of pipelines which are under an electrical voltage and lead together into a manifold, it is important to insulate them before connection to a manifold in order to avoid short-circuits because of the different voltage levels of the supply pipelines.

Especially in hydrogen generators with stacks connected in series, supply lines into the manifold have to be designed as electrically insulated because the stacks are at different voltage levels and would otherwise cause short-circuits.

Pipe connections are known from the prior art which have, between two flanges, an insulating plate or a layer of varnish for the purpose of insulation, as can be seen in FIG. 4. Such flange connections cannot be used in the case of media which are transported through the pipes and have a certain conductivity because a diameter-dependent minimum distance is required to achieve the minimum necessary insulation resistance. Such flange connections are not suitable for hydrogen generators.

WO 2023/067565 A1 discloses an insulating connection of a pipeline, wherein the insulation is monitored constantly in order to ensure that there is no damagingly high flow of current. Impairment of the insulation because of a reduction in the insulation resistance of the insulation could result, for example, in the appearance of corrosion which would impair the mechanical properties of the insulating connection and could even cause failure with the resulting safety problems both for the pipeline and for the operators.

The disadvantage of insulations which virtually completely prevent conductivity is that dirt with sufficient moisture forms an electrolyte at an insulating part, as a result of which a leakage current flows. If the leakage current is interrupted at one point by drying of the dirt, a breaking spark occurs at this point. The energy thereof causes a partial change in the insulating material by thermal “charring”, which damages the material and generates progressively conductive paths which in the long-term result in the formation of a leakage path and hence unforeseeably reduce the insulating capacity of the insulating material.

An aspect of the invention is to propose an insulation fitting in which no breaking sparks occur, even when there is dirt present, when used in metal pipelines which are under an electrical voltage and are preferably suited for transporting media which have a certain conductivity.

### SUMMARY

This aspect is achieved by the plastic pipe of the insulation fitting for the purpose of insulation being conductive. Because the plastic of the plastic pipe of the insulation fitting is produced from a conductive plastic, a continuous flow of current is generated via the insulation fitting, by virtue of which local voltage differences are avoided. It should preferably be noted that no voltage drop is generated by virtue of the specific contact resistance ρ of the plastic pipe when conductive dirt at one point dries up and its leakage current is consequently interrupted, i.e. no current chopping takes place. The occurrence of breaking sparks when dirt dries up is thus prevented because the current can flow through the conductive plastic and thus no significant local voltage differences can occur. Dirt can occur at the internal and/or external diameter of the plastic pipe. The insulation fitting according to the invention for installation in a metal pipeline which is under an electrical voltage contains a plastic pipe and connecting elements, arranged thereon on both sides, for connecting the insulation fitting to the metal pipeline. The plastic pipe must have a certain length which corresponds to a diameter-dependent minimum distance in order to achieve the necessary insulation resistance, caused by the conductivity of the medium. Materials with a high CTI value are not suitable for having such a length because of their lower strength and poor temperature resistance. In addition, the insulation fitting according to the invention tends to become dirty quickly because of such a structural form, and this in turn results in possible leakage currents in the dirt which result in breaking sparks in the case of an interruption. Because of this, as described above, a conductive plastic is used in which the CTI value is not relevant and thus which also has the required stability and temperature resistance. The connecting elements can be made from plastic and/or a metal material. The plastic pipe for the purpose of insulation is conductive. It has been shown to be advantageous if the plastic pipe has a defined specific contact resistance ρ. The connecting elements are preferably also conductive.

It has been shown to be advantageous if the plastic pipe has a specific contact resistance ρ of between 10⁴ and 10⁹ Ωm. Conductivity of the plastic pipe is consequently obtained, as a result of which the flow of current via the plastic pipe is ensured and consequently no breaking sparks can occur.

The plastic pipe preferably has a specific surface resistance R□ of between 10⁵ and 10¹²Ω. The specific surface resistance is the electrical resistance measured at the surface of an object. The measurement is made between two parallel electrodes of a low width and a length. The specific surface resistance R□ of between 10⁵ and 10¹²Ω ensures that the conductivity of the surface of the plastic pipe is higher than that which is present in the case of possible dirt, or the surface resistance of the pipe is lower than that of the dirt, as a result of which the flow of current via the plastic pipe is ensured and no breaking spark occurs, even when the conductivity in the dirt decreases or is even eliminated altogether because the dirt has dried up.

It has been shown to be advantageous if the plastic pipe has a lower specific contact resistance ρ than the lowest occurring leakage resistance of the dirt. As already mentioned, this has the advantage that a constant flow of current in the plastic pipe is ensured.

A preferred embodiment has been shown to be one in which the plastic pipe has a lower specific surface resistance R□ than the surface resistance which is formed by the dirt at the outer surface of the plastic pipe. It is consequently ensured that the conductivity of the plastic pipe or its surface is greater than that which exists in the case of possible dirt, or the resistance of the plastic pipe surface is lower than that of the dirt, as a result of which the flow of current via the plastic pipe is ensured and no breaking spark occurs even when the conductivity in the dirt decreases or is even eliminated altogether because the dirt has dried up.

A preferred embodiment has been shown to be one in which the plastic pipe is produced from a compound. A non-conductive plastic is enhanced by the addition of conductive additives to form a conductive plastic.

The compound preferably has a thermoplastic as its base, wherein a conductive additive is admixed with the thermoplastic. Because the plastic pipe is not made from a non-conductive plastic and instead from a plastic which is conductive and allows a flow of current or this is desired, the CTI value of a plastic can be disregarded and there is a free choice of material or plastic.

A preferred embodiment has been shown to be one in which carbon is admixed with the thermoplastic in order to increase the conductivity. The carbon can be present in different forms such as fibres, powders, flakes and other known forms. Graphite is preferably admixed with the plastic as a conductive additive. Suitable additives for increasing the conductivity of the plastic are also stearates and specifically incorporated metallic salts such as, for example, CuCl₂.

A preferred embodiment has been shown to be one in which PEEK is used as the thermoplastic. Although PEEK belongs to the insulation group IIIb and has a leakage resistance of 100≤CTI<175, which is why PEEK is not recommended as an insulator at a voltage above 630 V according to the standard EN IEC 60664-1. Because in principle no breaking sparks can occur in the case of the insulation fitting according to the invention, PEEK can absolutely be used as a preferred plastic with a high stability and temperature resistance.

The insulation fitting according to the invention is preferably used as a means of connecting pipelines in a hydrogen generator. In the case of stacks of the hydrogen generator which are connected in series, the supply pipelines into the manifold must be designed as electrically insulating because the stacks are at different voltage levels and a short-circuit would otherwise occur. The magnitude of the voltage to be insulated is up to 1500 V, which imposes specific requirements on the construction and choice of materials, which is why the insulation fitting according to the invention is conductive and allows a flow of current, wherein no current chopping can occur by virtue of the specific contact resistance ρ of the plastic pipe.

The insulating fitting according to the invention is used in pipelines in which an electrical voltage of >630 V is present, and the insulation fitting is inserted into the pipeline there in order to avoid short-circuits.

All possible embodiments can be freely combined with one another and, in order to avoid repetitions, the features of the insulation fitting which are mentioned refer automatically to the use, and vice versa.

### BRIEF DESCRIPTION OF THE DRAWINGS

An exemplary embodiment of the invention is described on the basis of the figures, wherein the invention is not just restricted to the exemplary embodiment. In the drawings:

FIG. 1 shows a schematic illustration of an insulation fitting according to the invention which uses a conductive plastic.

FIG. 2 shows a schematic illustration of an insulation fitting from the prior art which uses a non-conductive plastic, and

FIG. 3 shows a schematic illustration of a hydrogen generator, and

FIG. 4 shows an insulating flange connection known from the prior art.

### DESCRIPTION OF THE PREFERRED EMBODIMENTS OF THE INVENTION

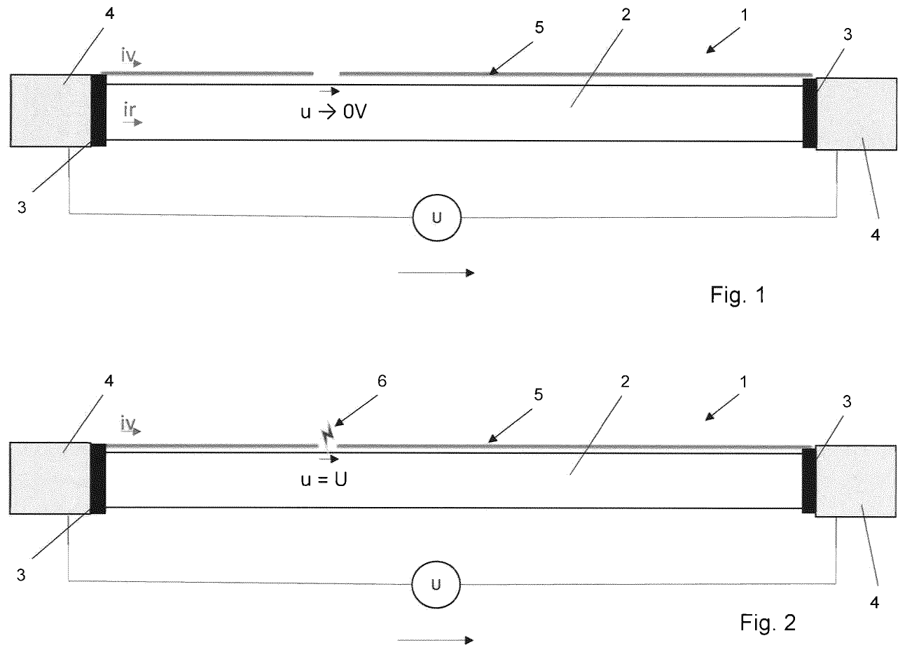

The drawing illustrated in FIG. 1 shows a schematic illustration of an insulation fitting according to the invention in which a conductive plastic is used. The fitting 1 according to the invention has a plastic pipe 2 arranged between two connecting elements 3. The connecting elements 3 can be made from plastic, an electrically conductive material or a metallic material. The insulation fitting 1 is installed in a metal pipeline 4 in order to avoid short-circuits between pipelines with different voltage levels.

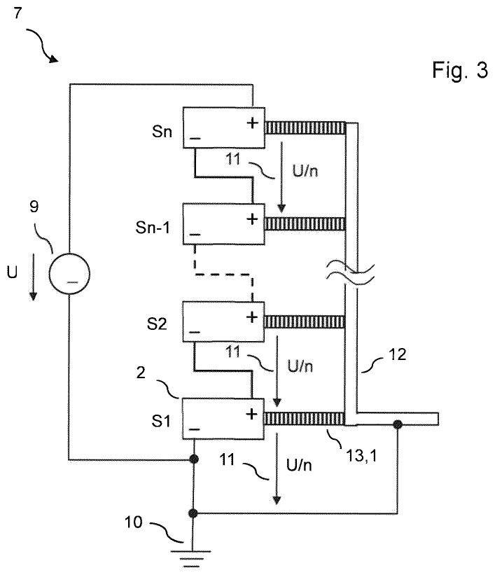

This use is preferably employed in the case of stack units 8, connected in series, of hydrogen generators, where the supply pipelines 13 into a manifold 12 must be designed as electrically insulating because the stack units 8 are at different voltage levels, see FIG. 3. The magnitude of the voltage to be insulated is up to 1500 V, which imposes specific requirements on the construction and choice of materials.

The dirt 5 on a plastic pipe 2, together with moisture, forms an electrolyte and a leakage current iv flows. When the leakage current iv is interrupted at one point by the dirt drying, a breaking spark 6 occurs there in the case of a plastic pipe which is non-conductive, see FIG. 2. Its energy causes a partial change in the insulating material by thermal “charring”, which damages the material and generates progressively conductive paths which in the long-term result in the formation of a leakage path and hence unforeseeably and undefinably reduce the insulating capacity of the insulating material. If, in contrast, a conductive plastic is used for the plastic pipe 2, the specific contact resistance ρ is less than the leakage resistance of the dirt 5, as a result of which a current ir flows in the plastic pipe 2 and, in the case of the dirt 5 being interrupted, a breaking spark no longer occurs because there is virtually no longer a voltage drop at the interruption.

FIG. 3 shows a schematic illustration of a hydrogen generator with a plurality of stack units 2 S₁ to Sₙ electrically connected in series. The voltage source 9, which is connected to a pole with an earth potential 10, feeds the stack units 8 with the voltage U. The latter is divided by the number n of stack units 8 as stack partial voltages 11 applied to the stack units 8. In order to feed the hydrogen generated by each stack unit 8 into the electrically conductive metal hydrogen manifold 12, the supply lines 13 must be electrically insulated with the insulation fitting 1 according to the invention in order to avoid short-circuits of the stack partial voltages 11 and to the earth potential 4. This task is assumed by the insulation fitting 1 according to the invention.

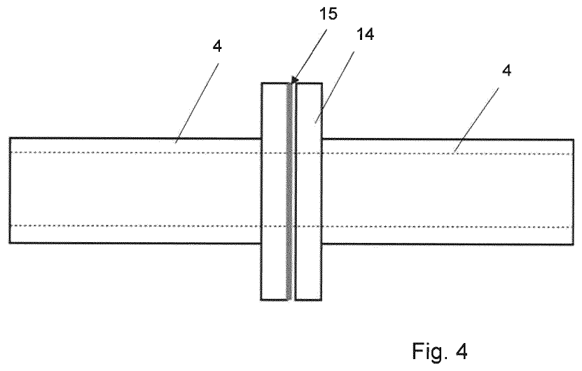

FIG. 4 shows a flange connection 15 known from the prior art with a layer of varnish or an insulation plate 15 between the two flanges 14 which connect the metal pipelines 4. As already mentioned, such a connection is not suitable for a medium which has a certain conductivity and instead a diameter-dependent minimum distance of the insulation fitting at which the medium forms a minimum insulation resistance is required for this, as is the case with the insulation fitting 1 according to the invention.

What is claimed is:

1. An insulation fitting (1) for installation in a metal pipeline (4) which is under an electrical voltage, comprising a plastic pipe (2) and connecting elements (3), arranged thereon on both sides, for connecting an insulation fitting (1) to the metal pipeline (4), wherein the plastic pipe (2) serves as insulation and is conductive.

2. An insulation fitting (1) according to claim 1, wherein the plastic pipe (2) has a specific contact resistance ρ of between 104 and 109 Ωm.

3. An insulation fitting (1) according to claim 1, wherein the plastic pipe (2) has a specific surface resistance R□ of between 105 and 1012Ω.

4. An insulation fitting (1) according to claim 1, wherein the plastic pipe (2) has a lower specific contact resistance ρ than the lowest occurring leakage resistance of the dirt (5).

5. An insulation fitting (1) according to claim 1, wherein the plastic pipe (2) has a lower specific surface resistance R□ than the surface resistance which is formed by dirt (5) at the outer surface of the plastic pipe (2).

6. An insulation fitting (1) according to claim 1, wherein the plastic pipe (2) is produced from a compound.

7. An insulation fitting (1) according to claim 6, wherein the compound has a thermoplastic as its base, wherein a conductive additive is admixed with the thermoplastic.

8. An insulation fitting (1) according to claim 7, wherein carbon is admixed with the thermoplastic in order to increase the conductivity.

9. An insulation fitting (1) according to claim 7, characterized in that PEEK is used as the thermoplastic.

10. The use of an insulation fitting (1) according to claim 1 for connecting pipelines (4) in hydrogen generators (7).

11. The use of an insulation fitting (1) according to claim 1, wherein the insulation fitting (1) is used for the purpose of insulation in pipelines (4) which have an electrical voltage difference of >630 V.
